(19) United States
(12) Patent Application Publication
(10) Pub. No.: US 2009/0249586 A1
(43) Pub. Date: Oct. 8, 2009

(54) ROPE GRIPPING TENSIONING DEVICE

(76) Inventor: Paul BROWN, San Marcos, CA (US)

Correspondence Address: EDWARD S. SHERMAN, ESQ., 3554 ROUND BARN BLVD., SUITE 303, SANTA ROSA, CA, 95403, US

(21) Appl. No.: 12/017,248

(22) Filed: Jan. 21, 2008

(51) Int. Cl. F16G 11/10

(52) U.S. Cl. 24/115 M

(57) ABSTRACT

A rope tensioning device configured to prevent unintentional disengagement of the device from the rope. A jam-cleat arrangement coupled with a closed or semi-closed passageway enables the device to function as a tensioning aid while the user may release the device without it falling off the rope.

### FIELD OF THE INVENTION

The present device generally relates to a rope pulling device and more specifically to a novel approach of manually creating tension on a rope or rope-like material with the device being able to constantly stay in contact with the rope without tension being applied.

### DISCUSSION OF PRIOR ART

Some general uses for a rope puller are in action sports which have the an ample need for manual manipulation of ropes such as windsurfing, kite-boarding, ice sailing, ice surfing, kite surfing, wing sailing, skate sailing, and other outdoor uses such as normal boat sailing, camping, tethering things onto vehicles, and the like.

In the different described uses of manually pulling on a rope or rope-like materials to create tension, a user must either use their bare hands, gloves, or some device to assist in creating tension. Using bare hands can create pain in the fingers and hand, friction burns, and raw patches on the skin from the friction or too much pressure. While gloves can alleviate some of these effects, they can create only as much tension as the user's hand can create grip-pressure on the rope. Various devices have been advanced to be placed on the rope to assist in manually creating more tension and to have a stronger and more efficient pull effect than just bare or gloved hands. The term “jam-cleat” may be used to refer to some such devices.

In many of these activities, the user does not have time to get an efficient grip on the rope, attach a pulling device to the rope, or to find and put on gloves. Many devices can be engaged onto the rope through various openings and passageways in the exteriors of those devices and create tension but such devices generally will not stay with the rope when the user releases tension on the rope and disengages from the means for gripping the rope, such as for re-gripping purposes. Once the tension is released and the rope disengages from the means for gripping the rope, the configuration of the openings and passageways create an annoying problem of the rope separating from the pulling device causing the user to grip the device in their hand or the device will fall off the rope. The problem can be illustrated in an example of a user pulling on the rope on a windsurfer and losing manual control of the pulling device. It would force the user to grab the line with one hand and affix the puller with the other hand making a one handed operation into a two handed one while also risking losing the device in the sea. One fix to control the device is to attach a strap to the device which the user would wear around their wrist. While this may be sufficient for keeping possession of the device if it inadvertently disengages, the user still has to regain manual control of the device and the rope and reattach the device when a rope pull is needed. In the event of quick action in some uses this is not optimal because the gripping device must be re-established in the user's hand and placed back on the rope.

### SUMMARY OF THE INVENTION

Broadly speaking, the invention solves the problem of a gripping tensioning device inadvertently disengaging from the rope by the configuration of its parts allowing the device to remain attached to the rope after tension is released. An embodiment of the invention may comprise a dimensioned handle, a passageway running along the handle which includes a groove, an aperture, optionally a slot opening in the exterior wall of the handle, optionally a means for enclosing the rope in the passageway, and a means for maintaining the rope inside the groove.

In one embodiment, the passageway has an aperture that is a smooth or non-smooth, generally cylindrical hole that can be located anywhere from near one end of the handle to being at or near the middle of the handle. In another embodiment of the invention, the passageway has an aperture that is open to the exterior by means of a slot opening in the handle, in a rectangular shape that is shaped to conform to the size of or slightly less than the diameter of the rope. In still another embodiment the passageway has a slot opening through the exterior wall and is optionally sealed by means of enclosing the rope in the device, with the preferred examples of the means for enclosure including a live hinge gate, a slidable gate, or a tongue-and-groove snap-lock covering arrangement. Another embodiment of the invention has a slot opening in the passageway that has convex edges near the exterior wall creating a tapering effect to the opening.

In some embodiments, the groove within the device has a rectangular shape or may be “V” or “U” shaped. The groove traverses some or all of the length of the handle, starting near the end of the handle or near the middle of the longitudinal central axis of the handle, and ending at the aperture at the opposite end of the handle. The groove's depth into the interior of the handle will allow a useable size of rope to be placed in it.

In some embodiments, the means for gripping the rope is at least one set of chevron shaped ridges, angled about 10 to about 90 degrees from the longitudinal central axis, each being triangular or having a saw tooth shape, set on a bias, arranged on opposite sides of the groove. The convergence of the set of ridges allows a rope to be wedged down between the ridges as the rope moves through the passageway. In still other embodiments, the number of sets of ridges is about two to about eight. The means may be a jamming cleat, a cam, and devices that are similar.

Another aspect of the present invention is a method of using the device For example, the device can be used to pull on a halyard rope on a sail boat. This method would be substantially described as placing the embodiment on the rope, wrapping the rope through the device, grasping in the correct manner, and pulling on the rope. The device would enable a person to pull, then optionally re-grip the rope in another area and pull again. Once the user releases tension and, in this example, uncleats the rope, the device would stay coupled on the rope.

### BRIEF DESCRIPTION OF THE DRAWING

The objects, features and advantages of the invention will become clearer when one reads on the following specification, taken together with the drawing, in which:

FIG. 1 is a side view of a device in accordance with the invention, with embodiments of the groove, means for gripping and the aperture shown interiorly as dashed lines;

FIG. 2 is a right end view of the device of FIG. 1;

FIG. 3 is a bottom view of the device of FIG. 1;

FIG. 4 is an axonometric view of the device of FIG. 1 looking at an angle onto the bottom thereof;

FIG. 5 is a vertical cross-section view taken along the cutting plane 3-3 in FIG. 1;

FIG. 6 is a view similar to FIG. 4, showing a phantom representation of a rope-like material passing through the embodiment shown;

FIG. 7 is a perspective view of the FIG. 1 embodiment showing one way a hand may grip the device, showing a phantom representation of a rope-like material extending through the device;

FIG. 8 is a side view of another embodiment showing a bridging member in a slot opening to the passageway in accordance with the invention;

FIG. 9 is an end view of the device of FIG. 8 looking onto the opening to the groove;

FIG. 10 is a bottom view of the device of FIG. 8;

FIG. 11 is an axonometric view of the device of FIG. 8, looking at an angle onto the bottom thereof;

FIG. 12 depicts an alternative embodiment having a slot opening to the passageway,

FIG. 13 is an end view of the device of FIG. 12 looking onto the opening to the groove;

FIG. 14 is a bottom view of the device of FIG. 12;

FIG. 15 is an axonometric view of the device of FIG. 12, looking at an angle onto the bottom thereof;

FIG. 16 depicts an alternative embodiment having a removeable gate to the passageway;

FIG. 17 is an end view of the device of FIG. 16 looking onto the opening to the groove;

FIG. 18 is a bottom view of the device of FIG. 16;

FIG. 19 is an axonometric view of the device of FIG. 16, looking at an angle onto the bottom, showing the removeable gate detached from the device.

FIG. 20 shows another alternative embodiment of the invention with a convex exterior edge of the slot opening to the passageway;

FIG. 21 is an end view of FIG. 20 looking onto the opening to the groove;

FIG. 22 is a bottom view of the device of FIG. 20 and;

FIG. 23 is an axonometric view of the device of FIG. 20, looking at an angle onto the bottom.

FIG. 24 shows another alternative embodiment of the invention with a removeable bridging member in exterior edge of the slot opening to the passageway;

FIG. 25 is an end view of FIG. 24 looking onto the opening to the groove;

FIG. 26 is a bottom view of the device of FIG. 24 and;

FIG. 27 is an axonometric view of the device of FIG. 24, looking at an angle onto the bottom. The bridging member and an alternative bridging member is shown as detached.

FIG. 28 shows another alternative embodiment of the invention with a “V”-shaped slot opening to the passageway;

FIG. 29 is an end view of FIG. 28 with the dashed lines showing interior openings;

FIG. 30 is a bottom view of the device of FIG. 28 and;

FIG. 31 is an axonometric view of the device of FIG. 20, looking at an angle onto the bottom.

FIG. 32 is a side view of a device in accordance with the invention, with embodiments of the groove, means for gripping and the aperture shown interiorly as dashed lines;

FIG. 33 is a right end view of the device of FIG. 32;

FIG. 34 is a bottom view of the device of FIG. 32;

FIG. 35 is an axonometric view of the device of FIG. 32 looking at an angle onto the bottom thereof;

FIG. 36 is a vertical cross-section view taken along the cutting plane 4-4 in FIG. 32;

FIG. 37 is a side view of a device in accordance with the invention, with embodiments of the groove, means for gripping and the aperture shown interiorly as dashed lines;

FIG. 38 is an end view of the device of FIG. 37;

FIG. 39 is a bottom view of the device of FIG. 37;

FIG. 40 is an axonometric view of the device of FIG. 37 looking at an angle onto the bottom thereof;

FIG. 41 is a vertical cross-section view taken along the cutting plane 5-5 in FIG. 37.

### DETAILED DESCRIPTION OF THE PREFERRED EMBODIMENTS

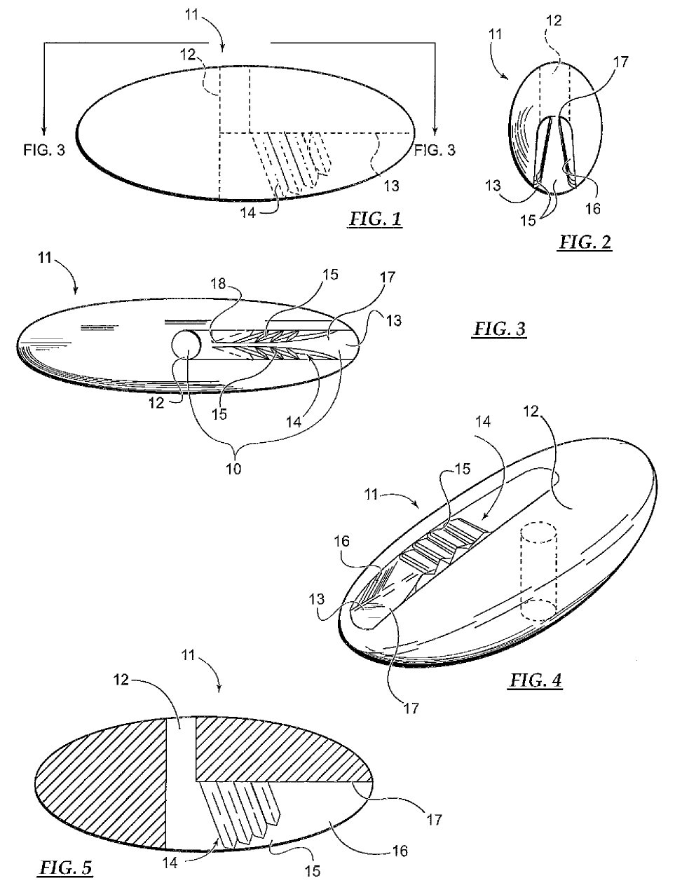

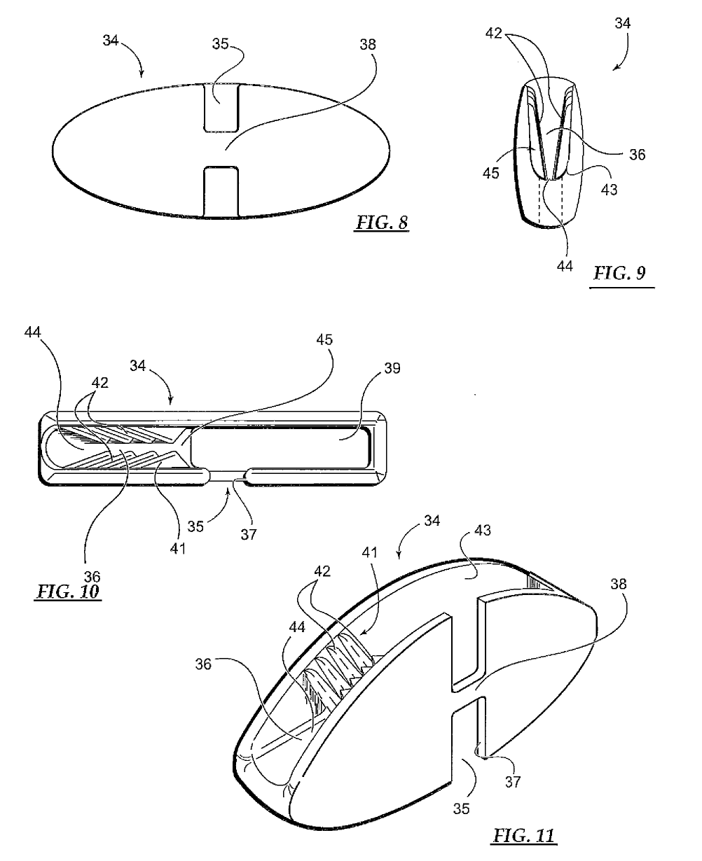

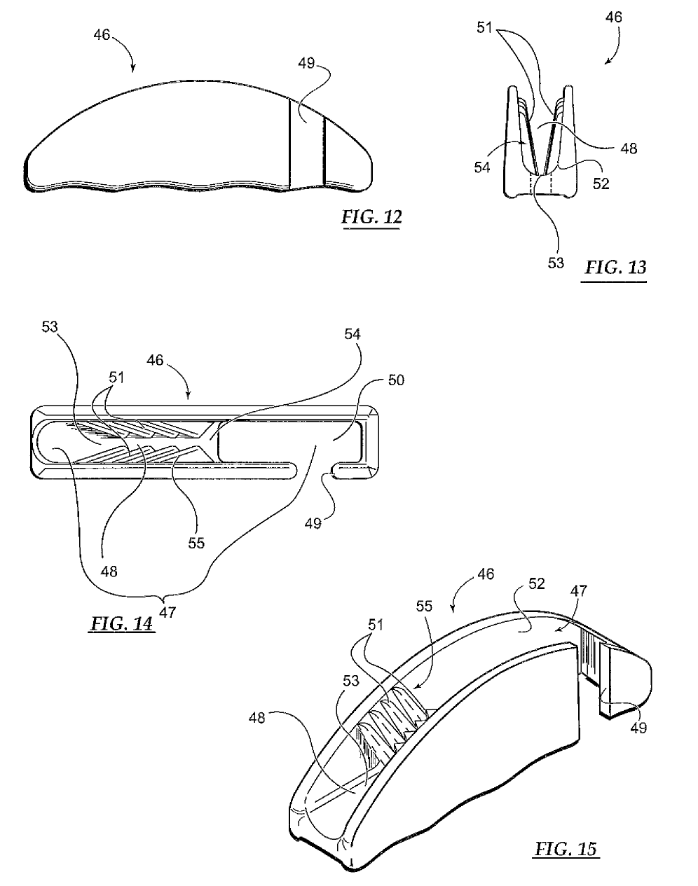

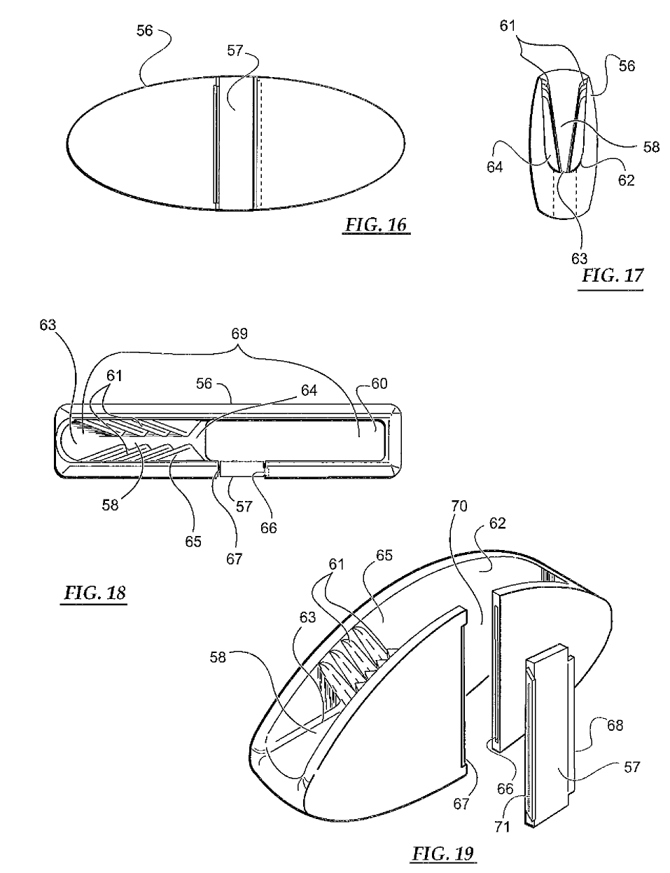

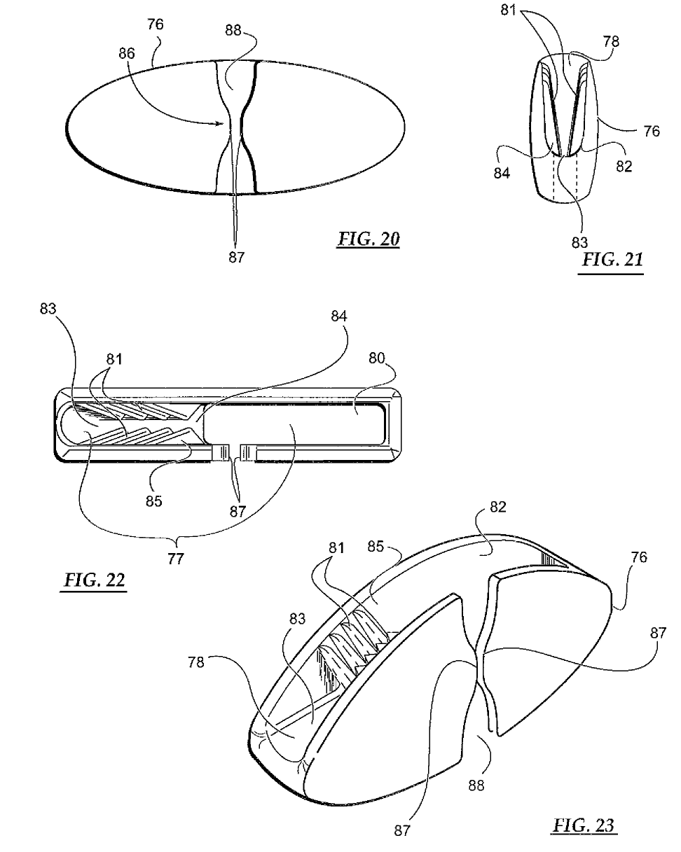

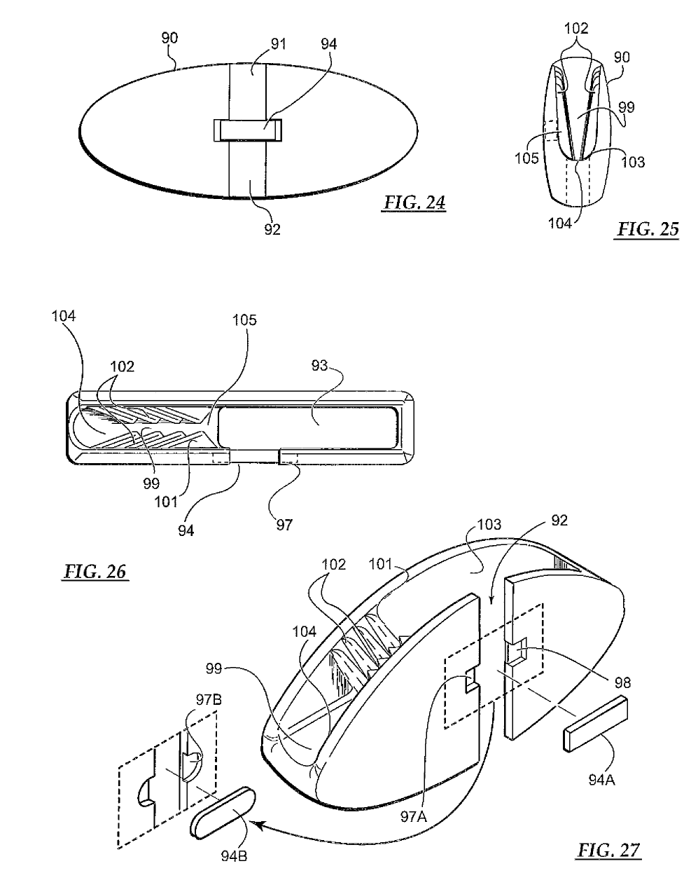

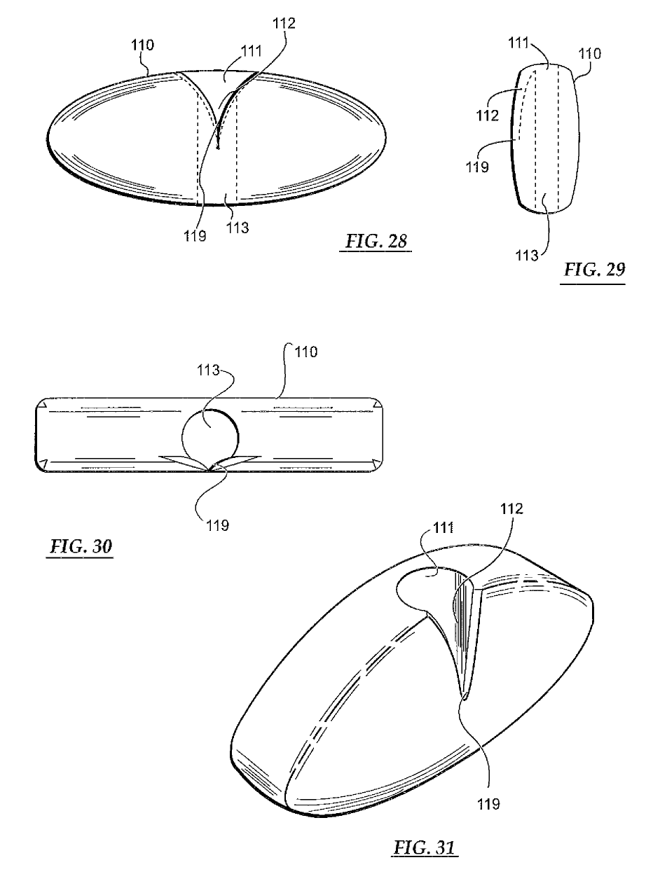

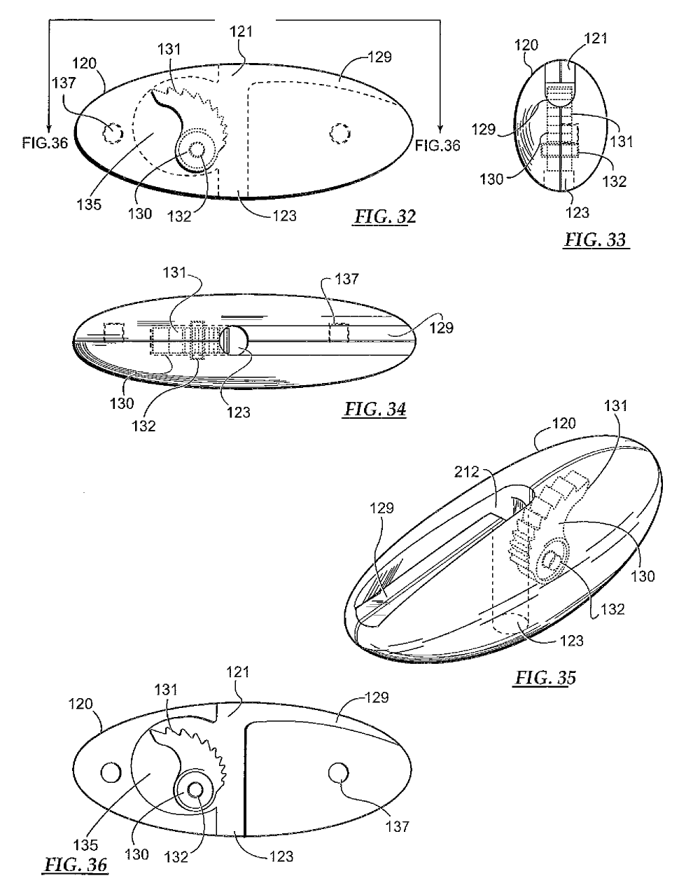

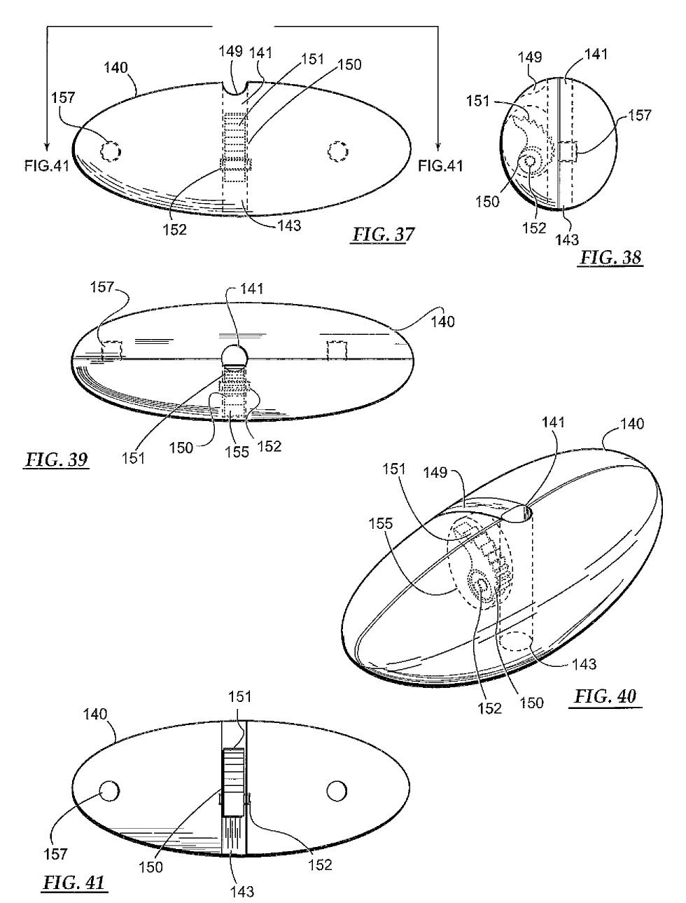

Throughout this description, the embodiments and examples should be considered as exemplars, rather than as limitations on the present invention. In the following paragraphs, embodiments of the present invention will be described in detail by way of example with reference to the attached drawing. The word “rope” used throughout this description describes any rope-like material such as braiding, bungee, cable, cordage, hawser, lace, lanyard, lariat, lasso, line, strand, strap, string, tape, thread, twine, or wire, made out of any suitable material It can be appreciated that, as used herein, “passageway” corresponds to the general areas of the handle in which the rope would pass along or through. The “groove” corresponds to any shaped area in the passageway of the device handle that has a solid component as to placing the rope upon or in. The “aperture” is any area of the passageway that creates a hole in the handle allowing the rope to pass therethrough. The “slot” or “slot opening” are used interchangeably and refer to any opening in the exterior wall of the handle that may allow the rope to have access to the passageway. The slot may in certain embodiments have static or removeable impediments to the rope being placed laterally through the exterior wall into the interior passageway. “Handle” and “device” are used interchangeably when describing the body of the device. As described herein, the passageway includes groove 15 in FIGS. 1-7, groove 36 in FIGS. 8-11, groove 48 in FIGS. 12-15, groove 58 in FIGS. 16-19, groove 78 in FIGS. 20-23, groove 104 in FIGS. 24-27, groove 119 in FIGS. 28-31, groove 129 in FIGS. 32-36, groove 149 in FIGS. 37-41, and “slot openings” described as slot 37 in FIGS. 8-11, slot 49 in FIGS. 12-15, slot 70 in FIGS. 16-19, slot 88 in FIGS. 20-23, and slot 112 in FIGS. 28-31, together with the “aperture” as described as aperture 12 in FIGS. 1-7, aperture 39 in FIGS. 8-11, aperture 50 in FIGS. 12-15, aperture 60 in FIGS. 16-19, aperture 80 in FIGS. 20-23, aperture 93 in FIGS. 24-27, aperture 113 in FIGS. 28-31, aperture 123 in FIGS. 32-36, and aperture 143 in FIGS. 37-41.

Referring to FIGS. 1-7, the tensioning device or handle of this embodiment is generally referred to by reference numeral 11. It is contemplated the device can be made from sturdy, lightweight, relatively rigid material, such as polymers, wood, or metals, but any material or method of manufacture may be suitable and the present invention is not limited to any particular method or material. It is contemplated that the device may have any shape that is suitable to be gripped by the user with either the left or the right hand. One skilled in the art can appreciate the contemplated embodiments of the device in helping to increase gripping power of the hand, together with comfort and efficiency of use of the device.

Referring to FIGS. 1-5, passageway 10 extends from aperture 12 side of device extending along groove 13, exiting the opposite end of device 11. In this embodiment, aperture 12 is shown to be located in about the center of the lateral and latitudinal axes, at about a 90 degree angle to the longitudinal central axis of the device. The aperture is contemplated to be located at any point along the longitudinal central axis of the device between the middle and the end and any point off dead center along the lateral axis. The aperture may have any angle from about 135 degrees to about 45 degrees from the longitudinal central axis. While the embodiment presented shows aperture 12 as a cylindrical hole, other three dimensioned shapes represented by triangles, squares, and other polygons are also contemplated. While the present embodiment of the invention manifests a smooth-walled aperture, other non-smooth or even patterned textures are contemplated as well.

Beginning near the aperture is groove 13 running longitudinally along handle 11. While FIG. 2 generally shows the embodiment of groove 13 to be “U”-shaped, other shapes such as “V” shape and rectangular shapes are contemplated. One skilled in the art would appreciate that the shape of the groove could be varied to allow different shaped jam-cleats, and rope gripping cams, and different sizes and shapes of ropes to be used.

Within the groove near the aperture is a structure shaped as a wedge for gripping the rope, the structure being generally referred in the drawing by numeral 14. This embodiment shows what is known as a jamming cleat and gripping means 14 will generally be referred to herein as a jam-cleat. Jam-cleat 14 is shown near the aperture but can be located anywhere along base 17 of groove 13. The jam-cleat in this embodiment is made up of a plurality, or multiple, of chevron shaped ridges 15, as seen in FIG. 3. Narrow side 18 of the chevron shaped ridges is preferably near the aperture. Ridges 15 are shown as sets of two, each one sitting opposite the other on walls 16 of the groove as seen in FIGS. 2-4. However, ridges 15 could function satisfactorily as a single set, opposite a flat wall 16. Ridges 15 would consist of about 1 to about 10 sets. The ridges rise on a bias from wall 16 at an angle from about 0 to about 10 degrees from the wall. The crest of each ridge 15 to its base has an angle that ranges from about 15 to about 100 degrees. The opposed ridges in the chevron shape have an angle from the longitudinal central axis of the handle that ranges from about 20 to about 90 degrees, preferably about 55 degrees.

One skilled in the art would appreciate that the rope will be gripped by ridges 15 in these geometric aspects differently depending on the type and size of the rope, the wear on the ridges, and the use for the device. In addition to jam-cleat 14, other means for gripping such as concentric and rotatable cams are contemplated as well as any means known in the art for gripping the rope that may be integrally formed with the handle.

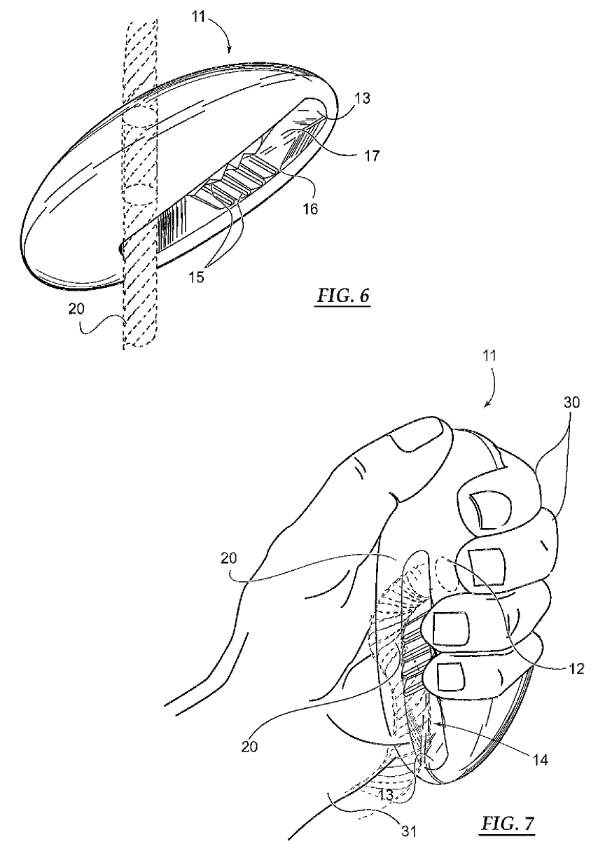

As shown in FIG. 7, it is contemplated that this embodiment of the invention will be used to put tension on a rope by threading rope 20 into the passageway 1 0 through aperture 12, laying the rope in groove 13 and wedging the rope between the chevron shaped angled ridges 15. The user would then place the grooved side of handle 11 in the user's palm 31 and wrap fingers 30 around the opposite side of handle 11, tucking the rope between the user's thumb and the adjacent end of groove 13. The user would then put tension on the rope by pulling on the device, until the need for tension was ended. Optionally, the user could slide the device along the rope and re-grip the rope. The user could then remove the hand and the device would generally be left secured to rope 20 (for example, see FIG. 6). The device would stay secured to the rope, not allowing inadvertent disengagement, until the user un-threads the rope from aperture 12.

Referring to FIGS. 8-11, an alternative embodiment device 34 is contemplated where the passageway 35 has a slot opening 37 to the exterior wall of the handle, near the center of the handle running from top to bottom of the handle. It is contemplated that aperture 39 would be generally rectangular in shape from the exterior wall of handle 34 to the beginning of groove 36. Attached to each opposing edge of the slot opening on the exterior wall is a fixed bridging member 38 spanning the gap between exterior wall edges of the slot. This bridging member can be fixed to the device anywhere along the edge of the slot, preferably in the center as seen in FIG. 8. One of ordinary skill in the art will appreciate this configuration of the passageway with the bridging member to prevent disengagement of the rope from the device. The rope must be threaded through the passageway starting either from the top in the aperture or from the bottom at the end of the groove. No lateral entry of the rope into the passageway is available in this configuration. Otherwise, the device of FIGS. 8-11 functions in essentially the same manner as the FIGS. 1-7 device, as has been described.

For completeness of description, device 34 is formed with jam-cleat 41 having ridges 42 extending from walls 43, and groove 36 having base 44 and narrow side 45.

Referring to FIGS. 12-15, an alternative embodiment is device 46 where passageway 47 has a slot opening 49 to the exterior wall of the handle, near an end of the handle running from top to bottom of the handle. It is contemplated that aperture 50 would be generally rectangular in shape from the exterior wall of handle 46 to the beginning of groove 48. It can be seen that the configuration of the passageway allows lateral entrance of the rope into the groove and the aperture and is such that the rope will not inadvertently disengage from the device. It is also contemplated that the aperture may be shaped to conform to the size of the rope or it preferably may be smaller than the size of the rope. This enables the rope, which is normally somewhat deformable, to be forced through slot opening into passageway. Similarly, this alternative configuration would not allow unintentional disconnection of the device from the rope. Otherwise, the device of FIGS. 12-15 functions in essentially the same manner as the FIGS. 1-7 device, as has been described.

For completeness of description, device 46 is formed with jam-cleat 51 having ridges 55 extending from walls 52, and groove 48 having base 53 and narrow side 54.

Referring to FIGS. 16-19, another embodiment contemplated is device 56 where passageway 69 has slot opening 70 in the external wall of the handle, generally central in the handle and running from top to bottom of the handle. The slot has slit 66 running along the length of the slot (to reduce confusion on the use of the word “groove” this is a “tongue-and-groove” type attachment but herein the groove receiving the tongue is called a slit), with the ends near the top and near the bottom of the device and near the exterior wall. The opposite slot edge will have cut-out slit 67 running along the length of the slot, with the ends near the top and near the bottom of the device. The cut-out slit cuts out the exterior edge of the slot opening preferably in this device in a right angle though other angles are contemplated from 1 degree to 179 degrees. The ends of the cut-out slit are angled to accept snap lock 71 of removeable gate 57. The slit and cut-out slit will be used for means of attachment and means for securing of a tongue-and-groove snap-lock removable gate to the handle. Removable gate 57 will be generally shaped to match the shape of slot opening 70 into the passageway. Running along the longitudinal ends of the tongue-and-groove snap-lock removeable gate is the complementary means for attachment to the exterior edges of the slot, preferably one side having a rectangular shaped tongue 68 shaped to fit the slit 66 creating a tongue-and-groove means for attachment. The opposite end has a parallelogram shaped tongue 71 shaped to fit the cut-out slit 67creating a snap-lock means for securing the gate. It is contemplated that this gate will be snapped on or off the handle to allow the rope to be laterally placed in and removed from the passageway. It is also contemplated that there be a thumb latch to allow for a quick removal or placement of the gate. Other means of attachment are contemplated in that the gate could be slid onto the handle by means of the slits in the groove utilizing a friction fit. Alternatives such as a live hinged gate with some common means of securing the gate in the closed position could be employed. A screw or other removable device could be used. Under certain circumstances it may be desirable to permanently secure the gate in place and any appropriate means, such as an adhesive, could be used. Otherwise, the device of FIGS. 16-19 functions in essentially the same manner as the FIGS. 1-7 device, as has been described.

For completeness of description, device 56 is formed with jam-cleat 61 having ridges 65 extending from walls 62 and groove 58 having base 63 and narrow side 64.

Referring to FIGS. 20-23, another embodiment contemplated is device 76 where passageway 77 has slot opening 88 in the external wall of the handle, generally central in the handle and running from top to bottom of the handle. The exterior edges of the slot have convex shape 86 toward the middle of the slot, creating a tapering of the slot opening shown near the transverse middle of the device, though it is contemplated the tapering could occur anywhere along the length of the exterior edge of the slot, or it could be more extensive than the convex shape shown, up to the entire length of the slot. Also, only one side of slot 88 could be straight and the other could be convex to any extent. The tapering is shown in a smooth equal mirror image convex curve shape but other smooth or non-smooth or equal or unequal curves and polygon shapes are contemplated. The distance between opposing apices 87 of the convex edges are contemplated to be less than the diameter of any aperture, so that the rope cannot be easily moved laterally into or out of the passageway through slot 88. One of ordinary skilled in the art will appreciate the distance between apices will not allow a lateral entry of the rope into the passageway and, conversely, when threaded through the passageway from either the top or the bottom, the device will stay attached to the rope. Otherwise, the device of FIGS. 20-23 functions in essentially the same manner as the FIGS. 1-7 device, as has been described.

For completeness of description, device 76 is formed with jam-cleat 81 having ridges 85 extending from walls 82 and groove 78 having base 83 and narrow side 84.

Referring to FIGS. 24-27, an alternative embodiment device 90 is contemplated where the passageway 91 has a slot opening 92 to the exterior wall of the device, generally near the center and running from top to bottom of the device. It is contemplated that aperture 93 would be generally rectangular in shape from the exterior wall of the device to the beginning of groove 99. Attachable to each opposing edge of the slot opening on the exterior wall is a removeable bridging member 94 spanning the gap between exterior wall edges of the slot. This bridging member can be fixed to the device anywhere along the edge of the slot, preferably in the center as seen in FIG. 24. Two alternatives are contemplated for embodiments of the bridging member including rectangular bar 94a and oval bar 94b. For the rectangular bar member, the edges of slot 97a would be formed to conform to the shape of the bar. A blocking ledge 98 that is approximately less than ½ the thickness of the exterior wall prevents bar 94a from passing through slot 97a into the interior of aperture 93. The thickness of bar 94a is less than the thickness of the exterior wall by an amount generally equal to the thickness of ledge 98. The inner dimensions of slot 97a are preferably slightly less than the dimension of the rectangular bar to provide a friction fit. For the cylindrical bridging member 94b, the edges of the slot would be cut out 97b to conform generally to the shape of the cylinder The inner diameter dimension of the cut-out would be slightly less than the diameter of the cylinder allowing the cylinder, to be snapped into the cut-out areas. Other appropriate 3 dimensional polygon shaped members are also contemplated. One of ordinary skill in the art will appreciate this configuration of the passageway with the bridging member attached to prevent disengagement of the rope from the device. The rope can be threaded through the passageway starting either from the top in the aperture or from the bottom at the end of the groove. Lateral entry of the rope into the passageway is available in this configuration, when the bridging member is detached. Otherwise, the device of FIGS. 24-27 functions in essentially the same manner as the FIGS. 1-7 device, as has been described. It will be appreciated that the embodiment of FIGS. 24-27 is a variation of the removable gate embodiment of FIGS. 16-19. The bridging member, 94 or 57, could also be made of flexible material such as leather, a woven material, for example.

For completeness of description, device 90 is formed with jam-cleat 101 having ridges 102 extending from walls 103, and groove 99 having base 104 and narrow side 105.

Referring to FIGS. 28-31, an alternative embodiment device 110 is contemplated where the passageway 111 has a slot opening 112 to the exterior wall of the handle, preferably near the center of the handle generally in the shape of a “V” with the narrow point of the “V” in about the middle of the device and the open area of the “V” opening into one edge of the handle. Device 110 shows the “V”-shaped slot opening narrow side starting near the middle but it can start anywhere that is practical. It is contemplated that aperture 113 would generally be round in shape. Groove 119 is the narrow part of the “V”-shaped slot opening running only the thickness of the wall of the device. The rope must be threaded through the passageway starting either from the top or bottom of the aperture and placed into the groove of “V”-shaped slot opening. The “V”-shaped area in the vicinity of groove would act in similar fashion for gripping as the chevron shaped jam-cleat. It is contemplated that “V” have an angle from about 10 degrees to 120 degrees. No lateral entry of the rope into the passageway is available in this configuration Otherwise, the device of FIGS. 28-31 functions in essentially the same manner as the FIGS. 1-7 device, as has been described.

While slot 112 is shown opening laterally, or 90° with respect to the longitudinal axis, it could function from any angle orientation, from 0° to 90°.

Referring to FIGS. 32-36, an alternative embodiment device 120 is contemplated where a passageway 121 has generally cylindrical aperture 123 adjacent to groove 129 running transverse from top to bottom. The groove starts at the aperture and runs along the central line of the longitudinal axis. Interior to the device adjacent to the passageway is a hollowed out area 135 holding a rotatable cam 130 with saw-tooth patterned gripping means 131. The cam rotates about a hub 132 in the interior of the device. The saw toothed gripping means engages the rope in the passageway. The saw-tooth angles are contemplated to be from 20 degrees to 120 degrees. The rope must be threaded through the passageway starting at the bottom of the aperture from the perspective of FIG. 32. If the rope is threaded from the groove side of the passageway the cam will engage the rope preventing its passage through the device. Device 120 may be formed with hollowed out area 135 in any available or practical manner.

An alternative to threading the rope is an embodiment where the device is comprised of two halves separated along the longitudinal axis, for example. Other device structures of two or more parts may be employed. In this alternative embodiment, the rope would be placed in the passageway of the device half not holding the cam. The separate halves would snap together enclosing the rope in the passageway utilizing the guide pins 137 and some locking means. Once the rope is placed correctly in the passageway and the device pulled in the correct manner the cam will engage the rope. Otherwise, the device of FIGS. 32-36 functions in essentially the same manner as the FIGS. 1-7 device as has been described and similar alternate configurations of its corresponding parts are also contemplated.

Referring to FIGS. 37-41, an alternative embodiment device 140 is contemplated where a passageway 141 has a cylindrical aperture 143 adjacent to a groove 149 running transversely from top to bottom. The groove starts at the aperture and runs generally along the central line transverse from front to back. Interior to the device adjacent to the passageway is hollowed out area 155 holding rotatable cam 150 with saw-tooth patterned gripping means 151. The cam rotates about a hub 152 attached in the interior of the device. The saw toothed gripping means engages the rope in the passageway. The saw-tooth angles are contemplated to be from 20 degrees to 120 degrees. The rope must be threaded through the passageway starting from the bottom from the perspective of FIGS. 37 and 38. If the rope is threaded from the groove side of the passageway the cam will engage the rope preventing passage of the rope through the device. As with the embodiment of FIGS. 32-36, device 140 maybe formed with hollowed out area 135 in any available or practical manner.

An alternative to threading the rope is an embodiment where the device is comprised of two halves separated along the longitudinal axis, for example. Other device structures of two or more parts may be employed. In this alternative embodiment, the rope would be placed in the passageway of the device half not holding the cam. The separate halves would snap together enclosing the rope in the passageway utilizing the guide pins 157 and some locking means. Once the rope is placed correctly in the passageway and the device pulled in the correct manner the cam will engage the rope. Otherwise, the device of FIGS. 37-41 functions in essentially the same manner as the FIGS. 1-7 device, as has been described and similar alternate configurations of its corresponding parts are also contemplated.

In FIGS. 32-41 cam 130, 150 is shown at two different angles at 90° from each other. The cam could effectively function at any angle between 0° and 90° from that shown in either embodiment.

One of ordinary skill in the art would appreciate that the current and contemplated shapes and placements of the passageway are significant in holding the device secured to the rope after tension is released. The contemplated passageways will allow different flexibilities in threading the rope through the handle and will allow the embodiments with human effort to move along the length of the rope. The current and contemplated passageways will not allow inadvertent disengagement

While the present embodiment has been illustrated and described by means of specifics and alternatives, it is to be understood that numerous changes and modifications can be made herein without departing from the purpose and scope of the invention. Therefore it should be understood that the invention is not to be limited in any way except in accordance with the appended claims and their equivalents. The invention is not restricted to the illustrated embodiments, but it may be varied without departing from the scope of the inventive concept. The scope of the protection sought by the inventor will be shown from a fair reading of the claims that are appended hereto.

What is claimed is:

1. A rope gripping tensioning device having a passageway shaped and configured to admit a rope to pass therethrough, and being configured to prevent inadvertent disengagement of said device from the rope

2. The device of claim 1, and further comprising:
a dimensioned handle for manual manipulation, said handle comprising:
said passageway extending along said handle,
a groove extending along said passageway in said handle;
at least one means located in said passageway for gripping the rope; and
an aperture in said passageway extending through said handle adjacent to said groove, said aperture being shaped and configured to permit the rope to pass therethrough.

3. The device of claim 2, wherein said aperture is generally cylindrical.

4. The device of claim 2, wherein said means for gripping the rope is at least one set of chevron shaped ridges, the narrow side of said chevron shaped ridges being open allowing a rope to wedge between said ridges at the base of said groove, with the narrowing side of said chevron shaped ridges being closer to said aperture than the less narrow side of said chevron shaped ridges, said ridges being generally triangular in shape set on a bias, rising from the wall on opposite longitudinal sides of said groove.

5. The device of claim 4, wherein the angle of said chevron shaped ridges is about 10 degrees to about 90 degrees from longitudinal axis of said handle.

6. The device of claim 5, wherein the number of sets of said chevron shaped ridges is at least one.

7. The device of claim 2, wherein said means for gripping rope is a jamming-cleat device located in said groove

8. The device of claim 2, wherein said passageway in said handle has a slot opening in the exterior wall, wherein said groove extends lengthwise along central longitudinal axis terminating near said aperture, wherein said slot opening has a bridging member spanning the opposite edges of the slot opening, wherein lateral entry of the rope is prevented.

9. The device of claim 2, wherein said passageway in said handle has said slot opening in the exterior wall, wherein said groove extends lengthwise along central longitudinal axis terminating near said aperture, wherein said aperture is rectangular and whose narrow width engages the rope, wherein lateral entry of the rope into said passageway is allowed

10. The device of claim 2, wherein said passageway in said handle has said slot opening in the exterior wall, wherein said groove extends lengthwise along central longitudinal axis terminating near said aperture, wherein said means for enclosing rope in said device is selected from the group consisting of a live hinged gate, a slidable gate, and a tongue and groove snap-lock gate covering arrangement, wherein lateral entry of the rope into said passageway is selectively allowable.

11. The device of claim 10, wherein said means for enclosing rope in said passageway is a tongue and groove snap-lock gate covering arrangement.

12. The device of claim 2, wherein said passageway in said handle has a slot opening in the exterior wall, wherein said groove extends lengthwise along central longitudinal axis terminating near said aperture, wherein said slot opening opposite exterior edges are convexed with the gap distance between apices of the convex being less than the diameter of the aperture, wherein lateral entry of the rope into, and exit from, said passageway is prevented.

13. The device of claim 2, wherein said groove has a shape selected from the group consisting of rectangular shape, “V” shape, and “U” shape.

14. The device of claim 2, wherein said handle is dimensioned to be compatible with at least one hand of a user, wherein said aperture is a generally cylindrical hole near the end of said handle at the beginning of said groove, wherein said groove is generally “U”-shaped initiating near an end of said handle whose depth is sufficient to accommodate a rope, terminating at end of said handle, wherein said means for gripping the rope is at least one set of chevron shaped ridges, the narrow side of said chevron shaped ridges is open allowing the rope to wedge between said ridges at the base of said groove, with the narrowing side of said chevron shaped ridges being closer to said aperture than the less narrow side of said chevron shaped ridges, said chevron shaped ridges creating an angle with the central longitudinal axis of said handle, said ridges being generally triangular in shape and set on a bias, rising from the walls on opposite sides of said groove.

15. The device of claim 2, wherein said handle is dimensioned to be compatible with at least one hand, wherein said passageway has a slot opening running from top to bottom in the exterior wall of the handle, wherein said slot opening has bridging member spanning across the gap of opposite exterior wall edges of the slot opening centrally located on the slot, wherein said aperture is rectangular from the end of the groove near the means for gripping the rope to the opposite end of the handle, wherein said groove is “U”-shaped initiating near an end of said handle whose depth is enough to accommodate a rope terminating at the aperture, wherein said means for gripping the rope is multiple sets of chevron shaped ridges, the narrow side of said chevron shaped ridges being open allowing a rope to wedge between said ridges at the base of said groove, with the narrowing side of said chevron shaped ridges being closer to said aperture than the less narrow side of said chevron shaped ridges, said chevron shaped ridges creating an angle with central longitudinal axis of said handle, said ridges generally triangular in shape set on a bias, rising from the walls on opposite sides of said groove.

16. The device of claim 2, wherein said handle is dimensioned to be compatible with at least one hand, wherein said passageway has a slot opening running from top to bottom in the exterior wall of the handle near one end, wherein said aperture is rectangular from the end of the groove near the means for gripping the rope to the opposite end of the handle whose narrow width engages the rope, wherein said groove is “U”-shaped initiating near an end of said handle whose depth is sufficient to accommodate a rope and terminating at the aperture, wherein said means for gripping the rope is multiple sets of chevron shaped ridges, the narrow side of said chevron shaped ridges being open allowing a rope to wedge between said ridges at base of said groove, with the narrowing side of said chevron shaped ridges being closer to said aperture than the less narrow side of said chevron shaped ridges, said chevron shaped ridges creating an angle with central longitudinal axis of said handle, said ridges generally triangular in shape set on a bias, rising from the walls on opposite sides of said groove.

17. The device of claim 2, wherein said handle is dimensioned to be compatible with at least one hand, wherein said passageway has a slot opening running from top to bottom in the exterior wall of the handle, wherein said means for enclosing rope is a removeable tongue-and-groove snap-lock gate, wherein said aperture is rectangular from the end of the groove near the means for gripping the rope to the opposite end of the handle, wherein said groove is “U”-shaped initiating near an end of said handle whose depth is sufficient to accommodate a rope and terminating at the aperture, wherein said means for gripping the rope is multiple sets of chevron shaped ridges, the narrow side of said chevron shaped ridges being open allowing a rope to wedge between said ridges at the base of said groove, with the narrowing side of said chevron shaped ridges being closer to said aperture than the less narrow side of said chevron shaped ridges, said chevron shaped ridges creating an angle with central longitudinal axis of said handle, said ridges generally triangular in shape set on a bias, rising from the walls on opposite sides of said groove.

18. The device of claim 2, wherein said handle is dimensioned to be compatible with at least one hand, wherein said passageway has a slot opening running from top to bottom in the exterior wall of the handle, wherein said slot opening has convex opposing edges near the exterior wall creating a tapering of the slot opening near the exterior wall, with the gap distance between convex apices being less than the diameter of the aperture, wherein said aperture is rectangular from the end of the groove near the means for gripping the rope to the opposite end of the handle, wherein said groove is “U”-shaped initiating near an end of said handle whose depth is sufficient to accommodate a rope and terminating at the aperture, wherein said means for gripping the rope is multiple sets of chevron shaped ridges, the narrow side of said chevron shaped ridges being open allowing a rope to wedge between said ridges at the base of said groove, with the narrowing side of said chevron shaped ridges being closer to said aperture than the less narrow side of said chevron shaped ridges, said chevron shaped ridges creating an angle with central longitudinal axis of said handle, said ridges generally triangular in shape set on a bias, rising from the walls on opposite sides of said groove.

19. The device of claim 2, wherein said handle is dimensioned to be compatible with at least one hand, wherein said passageway has a slot opening running from top to bottom in the exterior wall of the handle, wherein said slot opening has a removeable bridging member spanning across the gap of opposite exterior wall edges of the slot opening centrally located on the slot, wherein said aperture is rectangular from the end of the groove near the means for gripping the rope to the opposite end of the handle, wherein said groove is “U”-shaped initiating near an end of said handle whose depth is enough to accommodate a rope terminating at the aperture, wherein said means for gripping the rope is multiple sets of chevron shaped ridges, the narrow side of said chevron shaped ridges being open allowing a rope to wedge between said ridges at the base of said groove, with the narrowing side of said chevron shaped ridges being closer to said aperture than the less narrow side of said chevron shaped ridges, said chevron shaped ridges creating an angle with central longitudinal axis of said handle, said ridges generally triangular in shape set on a bias, rising from the walls on opposite sides of said groove.

20. The device of claim 2, wherein said handle is dimensioned to be compatible with at least one hand, wherein said passageway has a slot opening in the shape of a “V” running from top to bottom in the exterior wall of the handle, wherein said aperture is rectangular from the end of the groove near the means for gripping the rope to the opposite end of the handle, wherein said groove is “V”-shaped across the exterior wall of the handle whose depth is enough to accommodate a rope, wherein said means for gripping the rope is the “V”-shaped configuration part of the passageway allowing rope to wedge between the narrowing side of the “V” in the groove, with the “V” creating an angle of about 55 degrees.

21. The device of claim 2, wherein said handle is dimensioned to be compatible with at least one hand of a user, wherein said aperture is a cylindrical hole near the end of said handle at the beginning of said groove, wherein said groove is generally “U”-shaped initiating near an end of said handle running longitudinally whose depth is sufficient to accommodate a rope, terminating at the aperture, wherein said means for gripping the rope is a rotatable cam.

22. The device of claim 22, wherein said handle capable of being split longitudinally into two separate halves.

23. The device of claim 2, wherein said handle is dimensioned to be compatible with at least one hand of a user, wherein said aperture is a cylindrical hole near the end of said handle at the beginning of said groove, wherein said groove is generally “U”-shaped initiating near the middle of said handle running transverse from front to back whose depth is sufficient to accommodate a rope, terminating at the aperture, wherein said means for gripping the rope is a rotatable cam.

24. The device of claim 22, wherein said handle capable of being split longitudinally into two separate halves.

25. The device of claim 2, and further comprising a slot opening in said passageway on an exterior wall thereof.

26. The device of claim 2, and farther comprising means for enclosing the rope in said passageway.

27. A method of using the device of claim 2, comprising:
threading the rope through said passageway;
laying the rope in said groove;
installing the rope into said means for gripping;
preventing inadvertent disengagement of the device from the rope;
grasping said handle with said groove side with file rope inserted pressed into the fingers and the palm of the hand of the user;
wrapping the user's fingers around opposite sides of said handle and pressing the rope into the groove;
pulling on said handle creating tensile force along length of the rope;
selectively sliding the device along the rope and repeating the pulling step; and
releasing device leaving it attached to the rope.
